(19) United States
(12) Patent Application Publication
(10) Pub. No.: US 2010/0164894 A1
(43) Pub. Date: Jul. 1, 2010

(54) METHOD FOR GENERATING A VIBRATION AND A PORTABLE TERMINAL USING THE SAME

(75) Inventors: Jin Yong KIM, Seoul (KR); Eun Jeong Ko, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/648,968

(22) Filed: Dec. 29, 2009

(30) Foreign Application Priority Data
Dec. 30, 2008 (KR) 10-2008-0136516

(51) Int. Cl. G08B 6/00; G06F 3/041

(52) U.S. Cl. 345/173; 340/407.2

(57) ABSTRACT

The present invention relates to a method for generating a vibration and a portable terminal using the same. The method includes displaying a coordinate for generating a vibration pattern, displaying, on the coordinate, a line image according to an input of the portable terminal user, generating a vibration pattern corresponding to the displayed line image, and storing the generated vibration pattern.

### CROSS REFERENCE TO RELATED APPLICATION

This application claims priority from and the benefit of Korean Patent Application No. 10-2008-0136516, filed on Dec. 30, 2008, which is hereby incorporated by reference for all purposes as if fully set forth herein.

### BACKGROUND OF THE INVENTION

1. Field of the Invention

Exemplary embodiments of the present invention relate to a method for generating a vibration and a portable terminal using the same. In particular, exemplary embodiments of the present invention relate to a method for generating a vibration pattern through user input, and a portable terminal using the same.

2. Description of the Background

Portable terminals have become widely used and can provide various services including, for example, call services and data transmission services. The services can also be implemented in a multimedia communications device. A portable terminal may inform a portable terminal user of an incoming call and/or message by using a vibration, a ring tone, or a visual indicator (e.g., lamp). In general, a ring tone may be used to indicate an incoming call and/or message, and a vibration or visual indicator may be used at locations or situations in which the user prefers not to have an audio output from the portable terminal. A portable terminal may, in general, include several ring tones. A user of the portable terminal can select a ring tone stored in the portable terminal for incoming communications (e.g., calls/messages), and/or may set the ring tone by acquiring the tone through wireless communications (e.g., wirelessly connecting and downloading a ring tone from the internet). Moreover, the sound volume of the ring tone can be controlled by using a sound volume control key-button. However, with regards to vibrations, a vibration intensity and a vibration pattern are set up by a designer or manufacturer of the portable terminal. It is difficult to add a vibration pattern or to change a preset vibration pattern. Accordingly, a user may be limited in the types of settings (e.g., vibration types) applied to the user's phone.

To address this deficiency, a method of generating a vibration pattern by using pre-defined template icons in the portable terminal was developed. However, since the user is still limited to vibration patterns associated with pre-set template icons, the user may not have the ability to apply other vibration patterns that the user desires. Moreover, if a large number of vibration pattern template icons are provided, the user may experience the inconvenience of a time-consuming search for a desired template icon among a list of potential vibration pattern template icons. Furthermore, according to the method, the user needs to set up the intensity of vibration and the vibration time for each selected template icon. This would further add to the inconvenience experienced by the user. Accordingly, it is necessary to provide a method for easily and conveniently generating various vibration patterns that the user wants to set up in a portable terminal.

### SUMMARY OF THE INVENTION

Exemplary embodiments of the present invention provide a method for easily and conveniently generating vibrations by using an intuitive interface and a portable terminal using the same.

Additional features of the invention will be set forth in the description which follows, and in part will be apparent from the description, or may be learned by practice of the invention.

Exemplary embodiments of the present invention disclose a method of generating a vibration pattern of a portable terminal. The method includes displaying a coordinate for generating a vibration pattern, and displaying a line image on the displayed coordinate in response to an input by a user of the portable terminal. The method further includes generating a vibration pattern corresponding to the displayed line image, and storing the generated vibration pattern.

Exemplary embodiments of the present invention disclose a portable terminal including a touch sensor, a display unit, a vibration generator, a controller and a storage. The touch sensor senses an input of a user of the portable terminal. The display unit displays a coordinate for generating a vibration pattern and a line image according to the user input. The vibration generator generates a vibration pattern. The controller receives an input signal corresponding to the user input, determines the vibration pattern based on the user input, and instructs the vibration generator to vibrate according to the vibration pattern. The storage stores the generated vibration pattern.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is block diagram illustrating a configuration of a portable terminal for the generation of a vibration pattern according to exemplary embodiments of the present invention.

FIG. 2 is a flowchart illustrating a vibration pattern generation method according to exemplary embodiments of the present invention.

FIG. 3A, FIG. 3B, FIG. 3C, FIG. 3D, FIG. 3E, FIG. 3F, and FIG. 3G are display screens of a portable terminal if a vibration intensity coordinate is selected as a vibration pattern generation coordinate according to exemplary embodiments of the present invention.

FIG. 4A, FIG. 4B, FIG. 4C, and FIG. 4D are display screens of a portable terminal if a vibration direction coordinate is selected as a vibration pattern generation coordinate according to exemplary embodiments of the present invention.

FIG. 5A and FIG. 5B illustrate vibration intensity coordinates based on a maximum vibration intensity value and a vibration time range according to exemplary embodiments of the present invention.

FIG. 6A and FIG. 6B illustrate vibration direction coordinates based on a vibration direction and a vibration time range according to exemplary embodiments of the present invention.

FIG. 7A, FIG. 7B, FIG. 7C, and FIG. 7D illustrate display screens for setting up and displaying a line image according to exemplary embodiments of the present invention.

FIG. 8 is a flowchart illustrating a vibration pattern generation method according to exemplary embodiments of the present invention.

FIG. 9A is a display screen showing a user-input line image according to exemplary embodiments of the present invention.

FIG. 9B is a display screen showing a corrected line image according to exemplary embodiments of the present invention.

FIG. 10 is a display screen showing a plurality of corrected line images according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Detailed descriptions of well-known functions and structures incorporated herein may be omitted to avoid obscuring the subject matter of the present invention.

Prior to explaining exemplary embodiments of the present invention, relevant terminology will be defined for the description below.

A ‘vibration pattern generation coordinate’ may refer to a vibration graph (i.e., coordinate system) used when a user of portable terminal generates a vibration pattern. The vibration pattern generation coordinate can include an X-axis coordinate and a Y-axis coordinate. The X-axis may correspond to a vibration time axis. The Y-axis can correspond to a vibration intensity axis or a vibration direction axis. In a vibration direction coordinate, the Y-axis can be divided into multiple directions (e.g., top, bottom, right, and left directions).

A ‘vibration intensity’ may refer to a preset vibration intensity level.

For illustrative purposes, a portable terminal is used to describe exemplary embodiments of the present invention. A portable terminal may be a terminal equipped with a vibration motor and a touch screen. However, exemplary embodiments of the present invention are not limited to a portable terminal. Exemplary embodiments of the present invention can be applied to all types of communication and information devices, multimedia devices, such as, a portable communications terminal, a portable multimedia player (PMP), a personal digital assistant (PDA), a smart phone, and a MP3 player.

Hereinafter, exemplary embodiments of the present invention are described in detail with reference to the accompanying drawings.

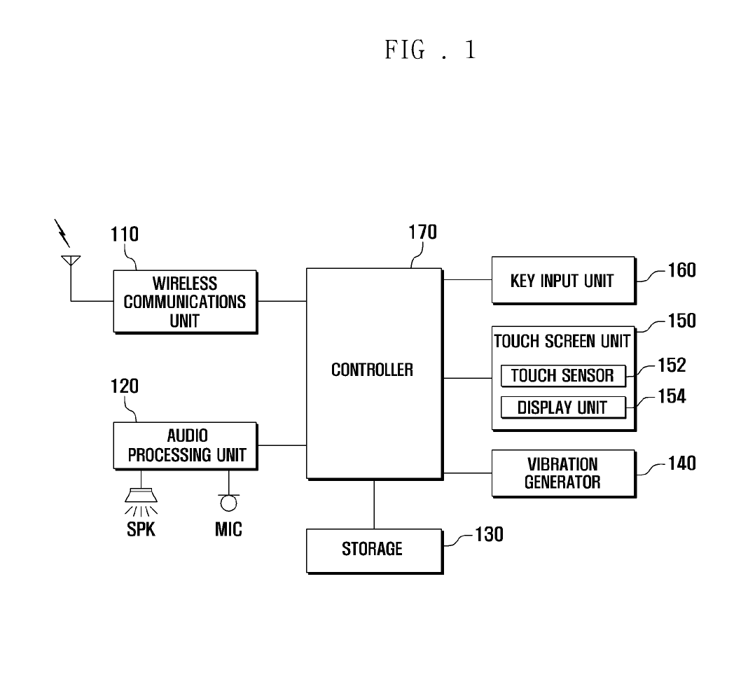

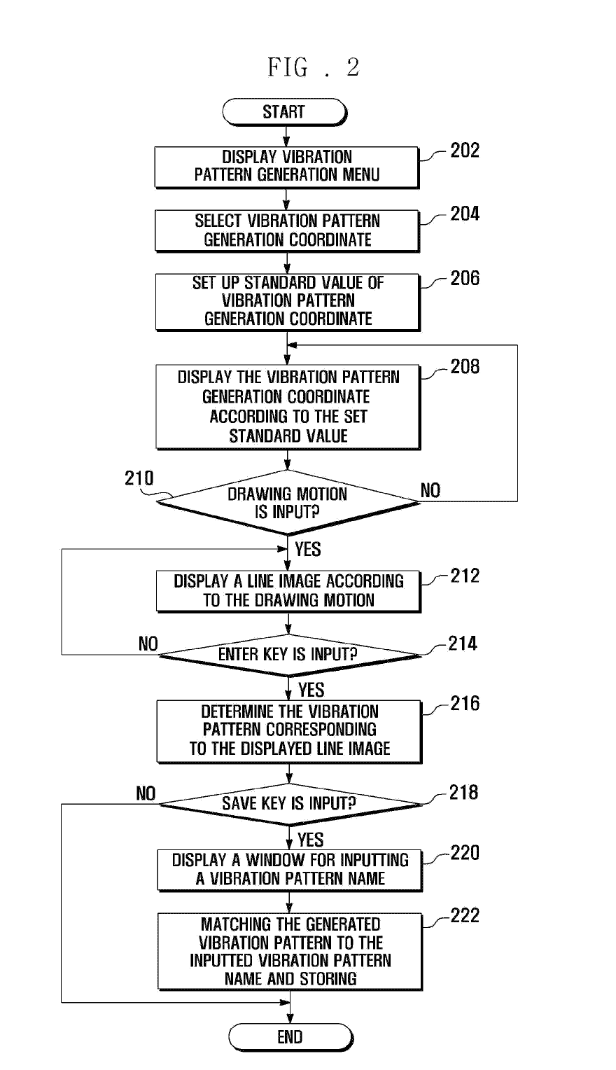

FIG. 1 is block diagram illustrating a configuration of a portable terminal capable is of generating a vibration pattern according to exemplary embodiments of the present invention.

The portable terminal may include a wireless communication unit 110, an audio processing unit 120, a storage 130, a vibration generator 140, a touch screen unit 150, a key input unit 160, and a controller 170. The wireless communications unit 110 may transmit and receive data used in wireless communications of the portable terminal. The wireless communications unit 110 can include a RF transmitter to up-convert and amplify a frequency of a transmitted signal, and a RF receiver to low-noise amplify and down-convert a received signal. Moreover, the wireless communications unit 110 may receive data through a wireless channel and may send the data to a controller 170. The wireless communications unit 110 may also transmit data outputted from the controller 170 to a wireless channel.

An audio processing unit 120 may include a codec. The codec may include a data codec to process packet data and an audio codec to process an audio signal (e.g., voice signal). The audio processing unit 120 may convert a digital audio signal into an analog audio signal through the audio codec and may play the audio signal using speaker (SPK). The audio processing unit 120 may also convert, using the audio codec, an analog audio signal inputted from the microphone (MIC) into a digital audio signal. When the controller 170 outputs a vibration through a vibration generator 140, the audio processing unit 120 can output a sound effect set up in response to the vibration pattern, with the vibration output.

A storage 130 may store programs and data necessary for operating the portable terminal. The storage 130 can be divided into a program area and a data area. The storage 130 may store a generated vibration pattern and/or a vibration graph. A vibration graph may be a graph consisting of a vibration pattern generation coordinate and/or a line image. The vibration graph may be used to determine a stored vibration pattern. The storage 130 can also store a vibration pattern name corresponding to the generated vibration pattern.

A vibration generator 140 may generate a vibration under the control of the controller 170. The vibration generator 140 may include a vibration motor which may generate various vibration intensities and vibration patterns. The vibration motor may have a coin shape, and may be positioned parallel to a display unit 154 of the portable terminal. The vibration motor may generate a vibration by a rotation of the vibration motor having an asymmetric mass distribution as a rotor.

The vibration generator 140 can include one or more vibration motors. If the vibration generator 140 includes a plurality of vibration motors, each vibration motor can be positioned in at least one portion (e.g., top, bottom, left, and right portions) of the portable terminal body.

For example, if the vibration generator 140 includes two vibration motors, vibration motors can be positioned in a top portion and a bottom portion of the portable terminal relative to the center of the portable terminal body. In some cases, the vibration motors may be placed in a left portion and a right portion of the portable terminal relative to the center of the portable terminal body. If the vibration generator 140 includes four vibration motors, the vibration motors can be positioned in top, bottom, left, and right portions of the portable terminal relative to the center of the portable terminal body.

A touch screen unit 150 may include a touch sensor 152 and a display unit 154. The touch sensor 152 may sense whether a touch tool contacts the touch screen. The touch tool can include a finger/hand of the user or a touch pen (e.g., stylus pen). The touch sensor 152 may be a touch-sensitive sensor, a pressure sensor, or, in general, any suitable sensor that can sense a contact and pressure of an object may be used. The touch sensor 152 can be formed on onesurface or one side of a portable terminal, and may, in some cases, perform the role of an input unit of the portable terminal. The touch sensor 152 may sense a user input to the touch screen 150 and, in response, may generate an input sensing signal to transmit to the controller 170. The input sensing signal may include location information of the input.

To describe exemplary embodiments of the present invention, a drawing motion may be illustrated as a user input to the touch screen. However, it should be understood that user input is not limited thereto, and that, in general, a user may provide any type of suitable input on the touch screen unit 150. The touch sensor 152 may sense the user input at a coordinate specified for vibration pattern generation, and may transmit the input sensing signal to the controller 170. The touch sensor 152 can also sense a pressure of the user input. The input sensing signal may include drawing location information and pressure information transmitted from the touch sensor 152 to the controller 170. By using the pressure information included in the input sensing signal, the controller 170 can determine the vibration intensity.

The display unit 154 can be a liquid crystal display (LCD) and may visually provide a menu of the portable terminal, inputted data, function setting information, and other information. For example, the display unit 154 may output a booting screen of the portable terminal, a stand-by screen, a display screen, a phone call screen, and any other suitable application execution screen.

The display unit 154 may display a vibration pattern generation coordinate. If the user inputs a drawing motion at the displayed coordinate, the display unit 154 may display a line image corresponding to the drawing motion. The display unit 154 can vary the thickness of the line image according to the pressure of the drawing motion being input. Moreover, the display unit 154 can vary display of the line image with a dotted line or solid line type according to a line type setting. The display unit 154 can amend and display the line image corresponding to the drawing motion according to the sensed vibration pattern under the control of the controller 170.

The key input unit 160 may receive a key manipulation signal input or provided by the user to control the portable terminal. The key manipulation signal may be sent to the controller 170 from the key input unit 160. The key input unit 160 can include a numeric key and a direction key, and can be formed on one side of the portable terminal with a set function key. In portable terminals that can perform functions and manipulations using only a touch sensor 152, the key input unit 160 can be omitted.

The controller 170 may control the overall operation of the portable terminal. If a vibration pattern generation command is input, the controller 170 may instruct the display unit 154 to display a vibration pattern generation coordinate. If the controller 170 receives an input sensing signal from the touch sensor 152, the controller 170 may instruct the display unit 154 to display a line image at the location the drawing motion is input. The controller 170 may generate a vibration pattern corresponding to the displayed line image, and may store the generated vibration pattern in the storage 130. The controller 170 can match a vibration pattern name to each vibration pattern and may store the vibration pattern name along with the vibration pattern in the storage 130.

In some cases, the controller 170 can determine that the vibration pattern corresponding to the line image is a combination of one or more vibration patterns stored in the storage 130. The controller 170 may instruct the display unit 154 to display the corrected line image corresponding to the determined vibration pattern. The controller 170 can also determine the vibration pattern according to a preset vibration time unit and vibration intensity unit. A configuration of the portable terminal for vibration pattern generation was described hereinabove. Hereinafter, a vibration pattern generation method is described.

FIG. 2 is a flowchart illustrating a vibration pattern generation method according to exemplary embodiments of the present invention.

A user may select a vibration pattern generation menu of the portable terminal. The vibration pattern generation menu can be included in a general menu of the portable terminal, and/or can be included in a user setting menu. If the user selects the vibration pattern generation menu by using the touch sensor 152 or the key input unit 160, the controller 170 may receive an input signal from the touch sensor 152 or the key input unit 160, and may instruct the display unit 154 to display the vibration pattern generation menu (202).

The vibration pattern generation menu may include a list of the vibration patterns generated in advance. The list of vibration patterns may be stored in the storage 130. The user can select a vibration pattern from among the listed vibration patterns, and can generate a new vibration pattern. If the user selects a menu to generate a new vibration pattern, the controller 170 may instruct the display unit 154 to display a menu to select a vibration pattern generation coordinate.

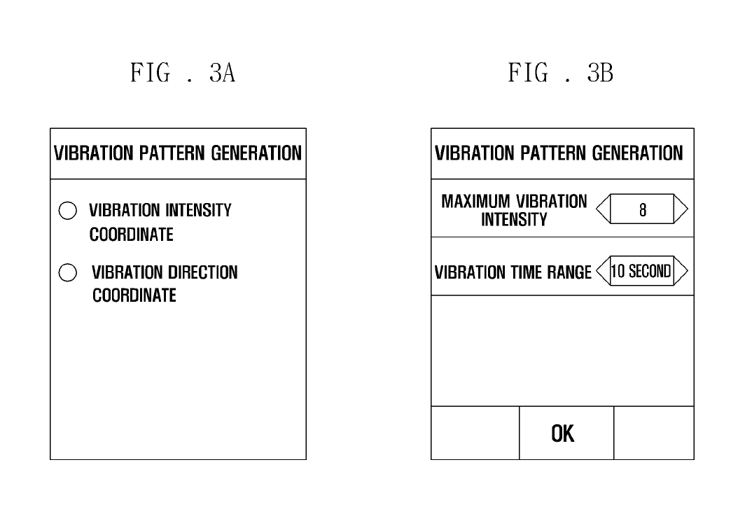

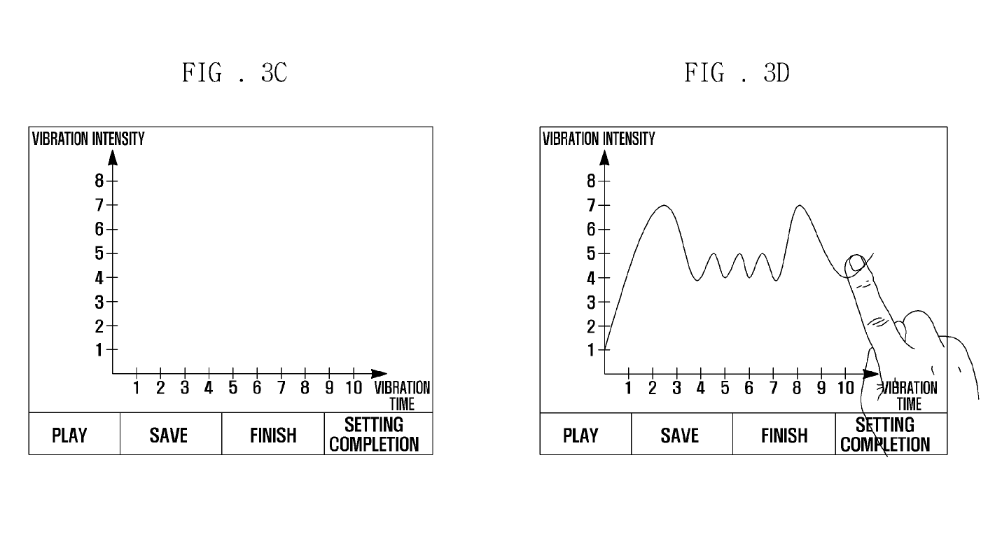

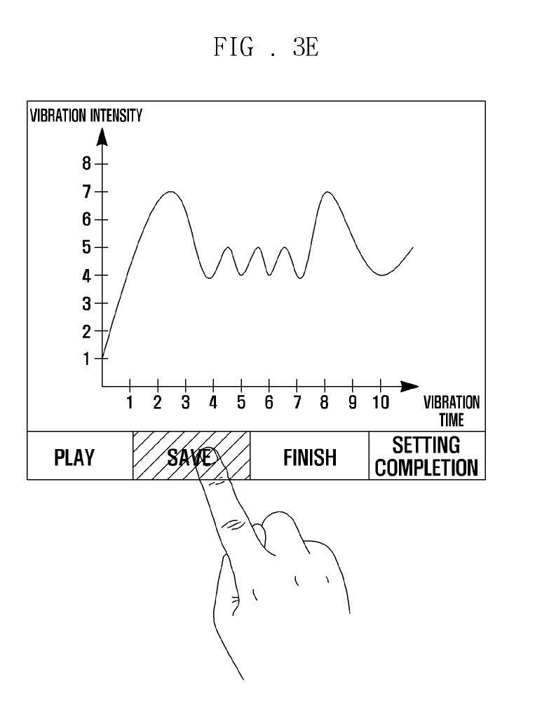

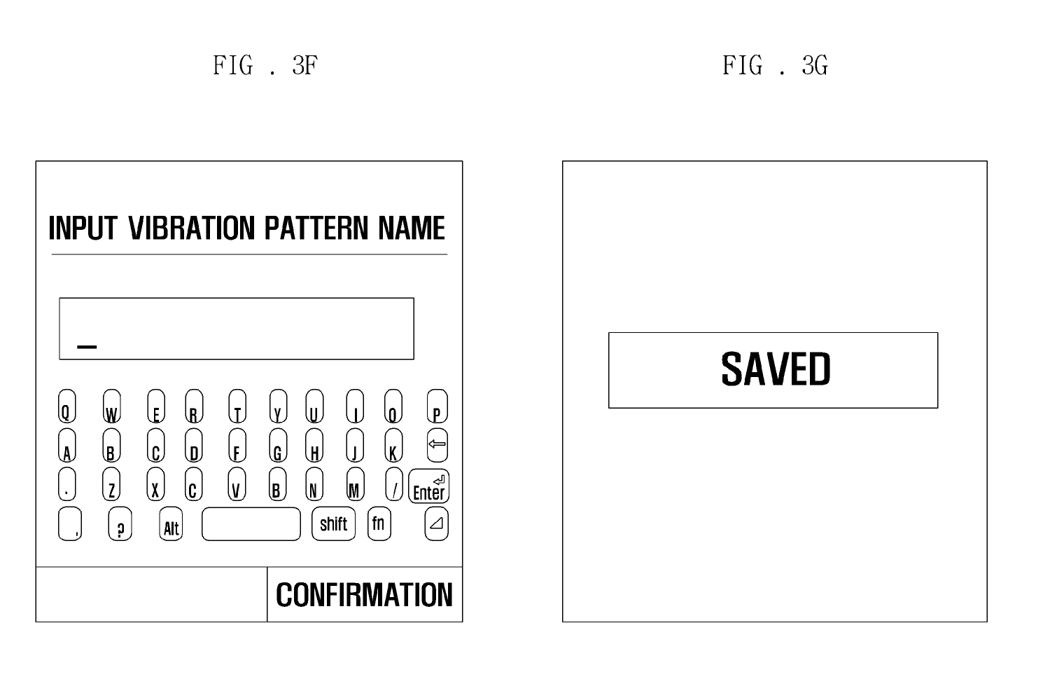

FIG. 3A illustrates a menu screen to select a type of vibration pattern generation coordinate. Vibration pattern generation coordinate types may include a vibration intensity coordinate and a vibration direction coordinate. In the vibration intensity coordinate, the X-axis may be a vibration time axis and the Y-axis may be a vibration intensity axis. In the vibration direction coordinate, the X-axis may be a vibration time axis and the Y-axis may be a vibration direction axis. The user may select one of the above-described coordinate types as the vibration pattern generation coordinate. If the vibration direction coordinate is selected, the portable terminal may perform like a terminal that can distinguish vibration direction, and the vibration generator 140 of the terminal can include one or more vibration motors. If a plurality of vibration motors is integrated into the portable terminal, vibration motors can be positioned in a top, bottom, left, and right portion of the portable terminal relative to the center of the portable terminal body. It should be understood that while exemplary embodiments of the present invention have described two types of vibration pattern generation coordinates, any number of suitable types of vibration pattern generation coordinates may be implemented and provided for selection in the vibration pattern generation menu.

If the user selects the vibration pattern generation coordinate (204), the controller 170 may determine that the type of coordinate is determined, and may control the display unit 154 to display a menu to set a standard value for the determined vibration pattern generation coordinate.

The standard value may correspond to data used in setting the form of the scale of the X-axis and the Y-axis of the vibration pattern generation coordinate. If the vibration intensity coordinate is selected as the vibration pattern generation coordinate, the standard value may correspond to a maximum vibration intensity value and a vibration time range. If the vibration direction coordinate is selected as the vibration pattern generation coordinate, the standard value may correspond to a vibration direction and a vibration time range.

FIG. 3B illustrates a menu screen used to set a standard value of a vibration intensity coordinate according to exemplary embodiments of the present invention.

The user can determine the Y-axis scale standards of the vibration intensity coordinate by setting up a maximum vibration intensity value. Vibration intensity and vibration intensity level may be determined and set according to a magnitude of the vibration acceleration. In some cases, the vibration intensity level may be set in the portable terminal in advance.

In FIG. 3B, the user sets the maximum vibration intensity value to 8. If ten vibration intensity levels ranging from level 1 to level 10 are defined in the portable terminal, the use can set the vibration intensity levels to range from level 8 to level 1 by setting the vibration intensity maximum value as eight. Moreover, the user can set up a vibration time range. The available maximum vibration time range may be preset in the portable terminal. The user can set the vibration time range within a range configured in the portable terminal.

In FIG. 3B, the user sets the vibration time range to ten seconds. If the maximum available vibration time range defined in the portable terminal is twenty seconds, the user may adjust the maximum available vibration time range to within ten seconds by setting the vibration time range to ten seconds. The vibration time range may be set using seconds as a unit, but can be set using a 0.1 or 0.01 second unit.

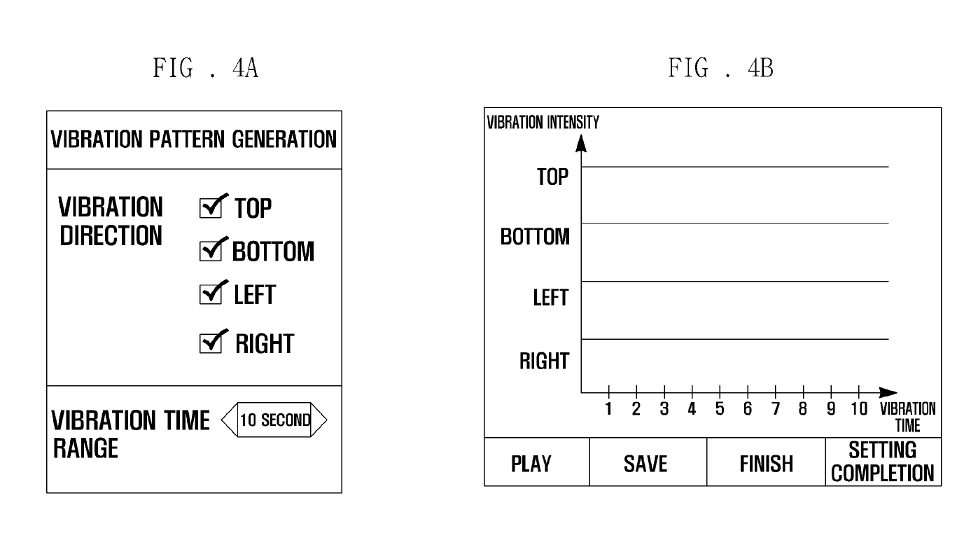

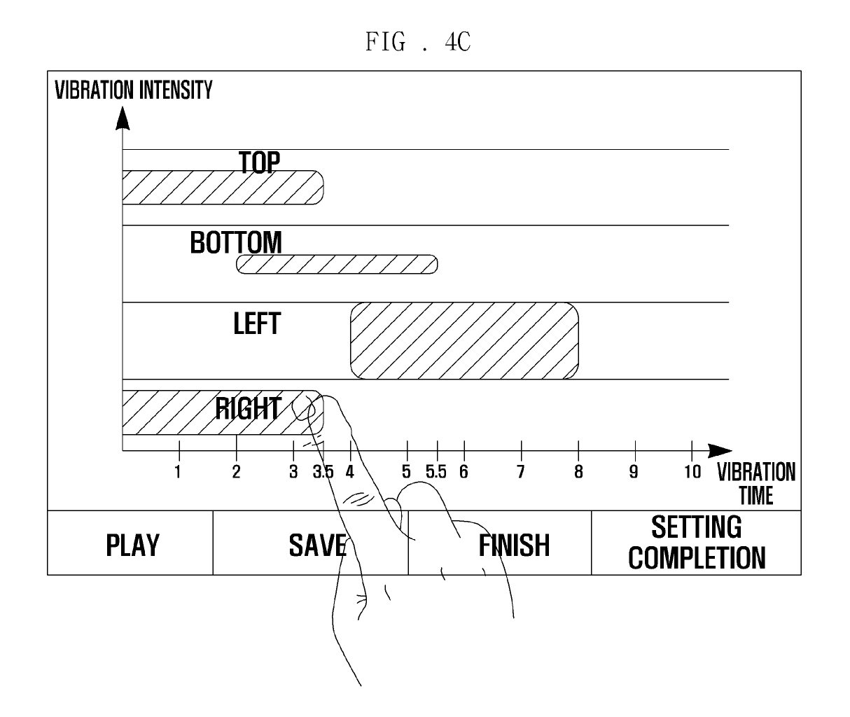

FIG. 4A illustrates a menu screen used to set a standard value of a vibration direction coordinate according to exemplary embodiments of the present invention.

In the vibration direction coordinate, the X-axis may be a vibration time axis and the Y-axis may be a vibration direction axis. The user can decide the displayed form of Y-axis by selecting the vibration direction. The user may select a vibration direction from among a top, bottom, left, and right direction, and can select one or more of the four directions.

In FIG. 4B, four directions including the top, bottom, left, and right are displayed. However, exemplary embodiments of the present invention are not limited thereto. For example, the portable terminal may control the vibration generator 140 in any suitable vibration direction. FIG. 4A illustrates a display screen in which the user may select the top, bottom, left, and right direction as a vibration direction.

The user can set the vibration time range as well as the vibration direction. The available maximum vibration time range may be defined in the portable terminal in advance and the user may set the vibration time range within the defined range. FIG. 4A illustrates a display screen in which the user sets ten seconds as a vibration time range. If the user inputs a standard value through the touch sensor 152 and/or the key input unit 160, the controller 170 may set the standard value (206) and may display the vibration pattern generation coordinate according to the set standard value on the display unit 154 (208).

FIG. 3C illustrates a vibration intensity coordinate based on the set standard value. At step 206, the maximum vibration intensity value may be set to level 8 and the vibration time range may be set to 10 seconds. Accordingly, the vibration intensity coordinate may be displayed with the X-axis having a range of 10 seconds while the Y-axis may be displayed with a range of 8.

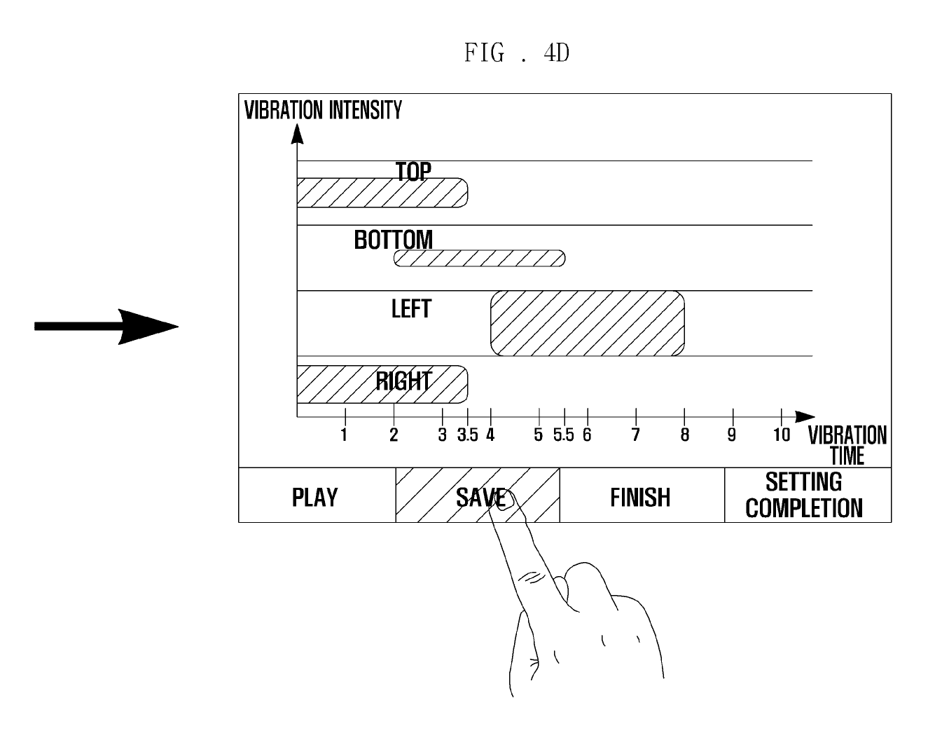

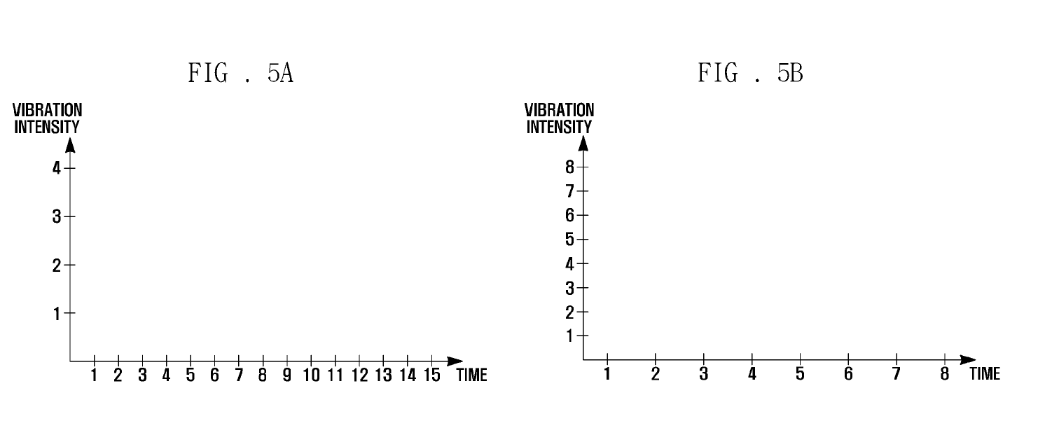

FIG. 5A and FIG. 5B illustrate a vibration intensity coordinate in which a maximum vibration intensity value and a vibration time range are set differently compared to FIG. 3C.

In FIG. 5A, the maximum vibration intensity value is 4 and the vibration time range is set to 15 seconds. In FIG. 5B, the maximum vibration intensity value is 8 and the vibration time range is set to 8 seconds. In some cases, the portable terminal user may preset the vibration intensity value and the vibration time range necessary for the generation of desired vibration pattern so that the portable terminal user can generate a vibration pattern in one screen without movement of the display screen. Moreover, the vibration intensity coordinate can be displayed according to the vibration time unit and the vibration intensity unit set in the portable terminal. If the unit of the vibration time is set to 0.1 second and the unit of vibration intensity is set to 0.1 in the portable terminal, the vibration intensity coordinate can be displayed with a cross stripe shape having dimensions of 0.1 second (X-axis) and 0.1 level (Y-axis) for one cell.

FIG. 4B illustrates a vibration direction coordinate according to a set standard value. At step 206, a top, bottom, left, and right direction may be set as the vibration direction, and the vibration time may be set to 10 seconds. Accordingly, the vibration direction coordinate may be displayed with the X-axis having a range of 10 seconds and the Y-axis may be divided into 4 areas so that a top, bottom, left, and right direction correspond to each area.

FIG. 6A and FIG. 6B illustrate a vibration direction coordinate in which a vibration direction and a vibration time range are set differently as compared to FIG. 4B.

In FIG. 6A, the vibration direction may be set to a top, and right direction, and the vibration time range may be set to 15 seconds. In FIG. 6B, the vibration direction may be set to a top and bottom direction, and the vibration time range may be set to 8 seconds. The portable terminal user may preset the vibration direction and the vibration time range necessary for the generation of a desired vibration pattern so that the portable terminal user can generate a vibration pattern in one screen without movement of the display screen.

The vibration direction coordinate can be displayed based on the vibration time unit and the vibration intensity unit. For example, in the vibration direction coordinate illustrated in FIG. 4C, each area corresponding to a top, bottom, left, and right direction is divided into, for example, 10 unit areas in the Y-axis direction, and the vibration time range is divided into 0.1 second time units so that the vibration direction coordinate can be displayed with a cross stripe shape.

According to some exemplary embodiments of the present invention, step 202 to step 206 can be omitted if the user selects a vibration pattern generation menu and the controller 170 may instruct the display unit 154 to display the vibration pattern generation coordinate as a default.

Referring back to FIG. 2, after step 208, the controller 170 may determine whether a drawing motion is input by the user in the displayed vibration pattern generation coordinate (210). If no drawing motion is input, the display unit 154 may continue to display the vibration pattern generation coordinate displayed in step 208. If a drawing motion is input, the touch sensor 152 may sense the drawing motion of the user, and may transmit location information of the input drawing motion to the controller 170. The controller 170 may control the display unit 154 to display a line image at the location where the drawing motion is input (212).

FIG. 3D, for example, illustrates a user input of a drawing motion in the vibration intensity coordinate. The controller 170 may display the line image according to the vibration time unit and vibration intensity unit set up in the portable terminal. In general, any suitable vibration time unit and vibration intensity unit may be used.

At step 208, if the vibration intensity coordinate is displayed with a cross stripe shape (e.g., FIG. 4C), the controller 170 can distinguish between a cell of the location to which the drawing motion is input and a cell of the location to which the drawing motion is not input, and can display the line image accordingly.

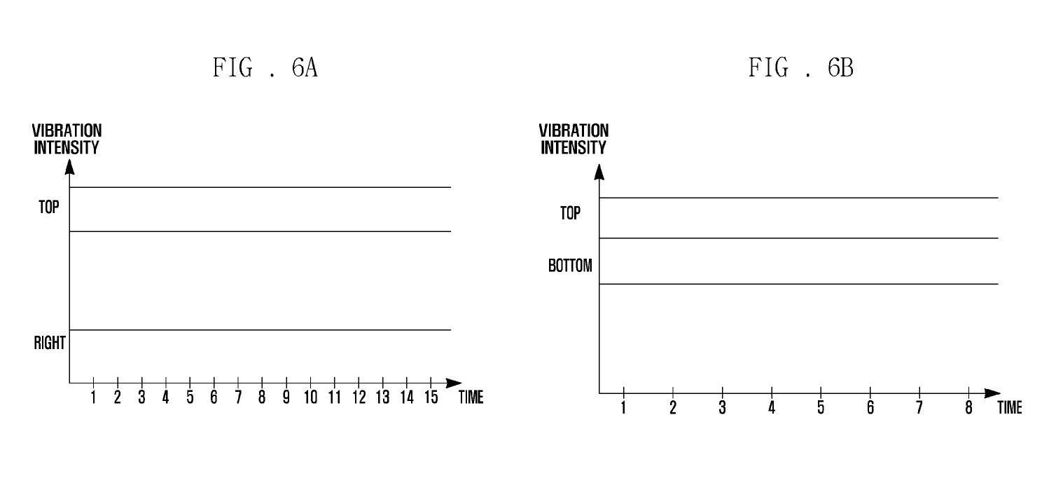

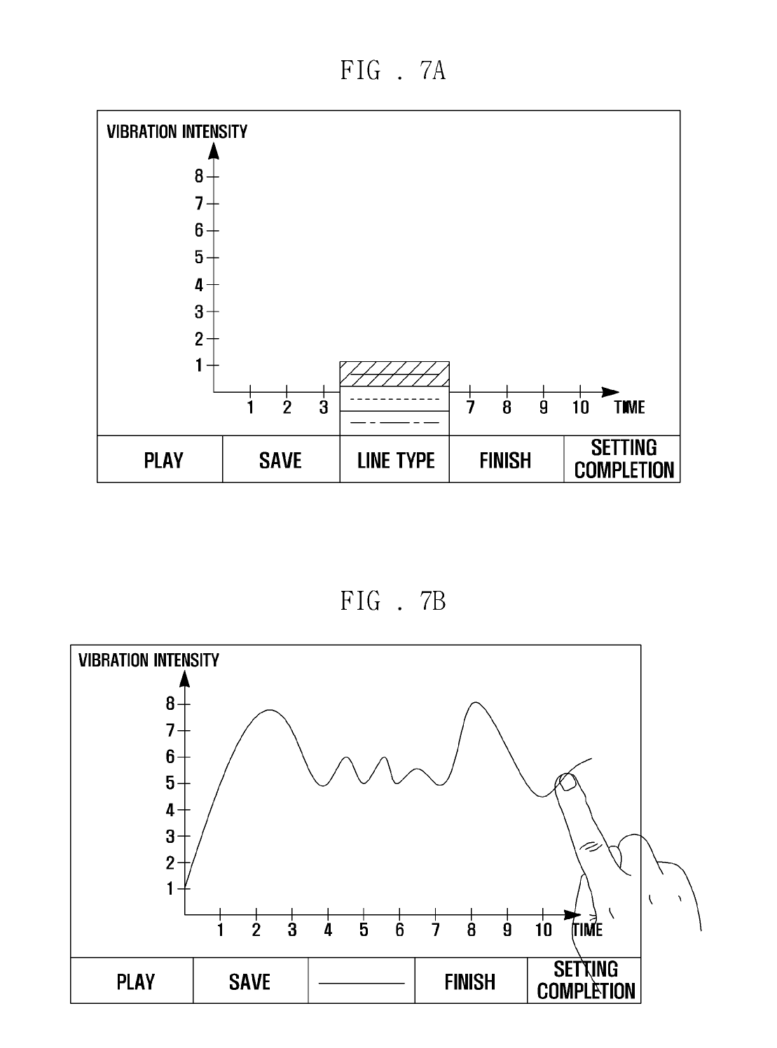

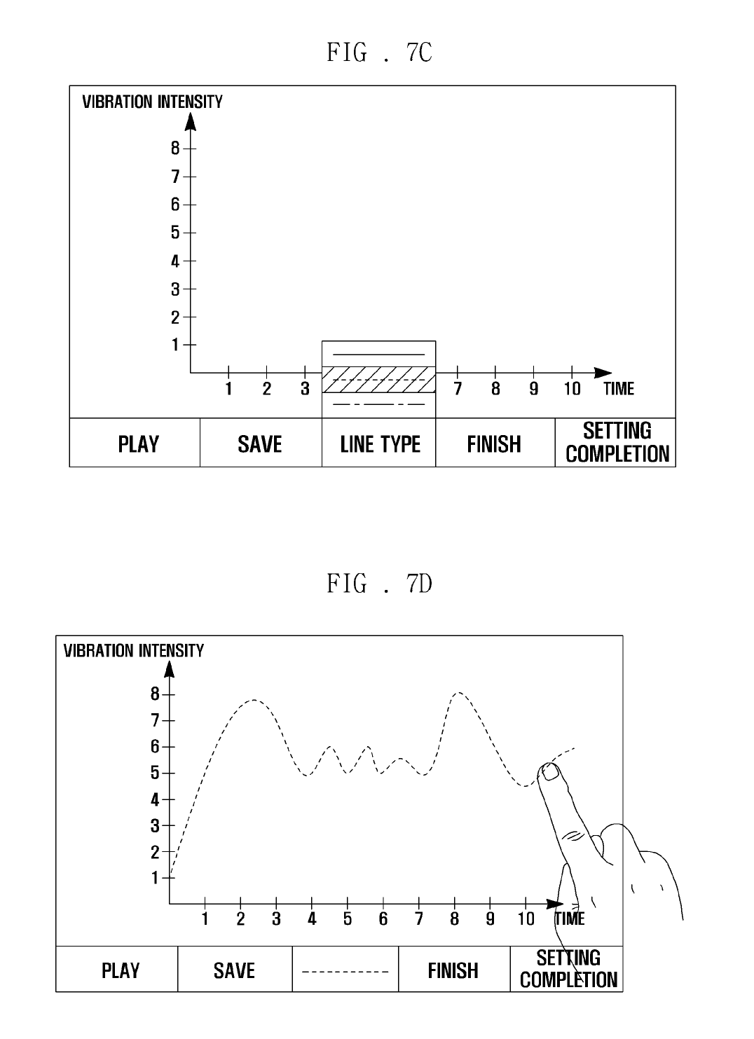

According to exemplary embodiments of the present invention, the user can select the type of line image to input and can input a drawing motion. For example, FIG. 7A and FIG. 7B illustrate the drawing motion of the user if a solid line is selected from various available types of lines. FIG. 7C and FIG. 7D illustrate a drawing motion of the user if a dotted line is selected from the various available types of lines. It should be understood that various types of lines may be used to draw the line image, and that the types of lines are not limited to the choices illustrated in FIG. 7A and FIG. 7C.

FIG. 7A illustrates a display screen in which the user selects a solid line as a line type. The user may input a drawing motion to the vibration pattern generation coordinate after selecting the solid line in a line type menu. FIG. 7B illustrates a user inputting a drawing motion to the vibration pattern generation coordinate. The display unit 154 may display an indicator that a solid line is selected, and the line image may be displayed with a solid line according to the drawing motion.

FIG. 7C illustrates a display screen in which the user selects a dotted line as a line type. FIG. 7D illustrates a user inputting a drawing motion to the vibration pattern generation coordinate. In FIG. 7D, a dotted line is displayed at the location where the user inputs the drawing motion. A line type used for the vibration pattern generation may be set up in advance. The user can generate a desired vibration pattern by selecting one out the preset line type. If a solid line is selected as the line type, a continuous vibration pattern may be generated. If a dotted line is selected, a discontinuous vibration pattern may be generated.

FIG. 4C illustrates an example of a user inputting a drawing motion to the vibration direction coordinate. If the user inputs a drawing motion to the vibration direction coordinate, the controller 170 may instruct the display unit 154 to display a line image according to the input drawing motion. When the display unit 154 displays a line image, the pressure applied while inputting the drawing motion is measured and the thickness of the line image is differently displayed according to the magnitude of the pressure. The vibration time, vibration direction, and vibration intensity may be determined by the user. For example, the user can set the portable terminal to simultaneously output a vibration in four directions (e.g., a top, bottom, right, and left direction) or in a single direction.

In FIG. 4C, the thickest line is displayed in the left direction and corresponds to a vibration time section of 4 to 8 seconds. In the top direction and the right direction, a line image thinner than the line image displayed in the left direction is displayed at a vibration time section of about 0 to 3.5 seconds. In the bottom direction, a line image thinner than the line image displayed in the left, top and/or right direction is displayed at a vibration time section of about 2 to 5.5 seconds.

The thickness of line image may be differently displayed according to the pressure by which the drawing motion is input. For example, the line image may be displayed using a thin line if the pressure is small, and the line image may be displayed using a thick line if the pressure is great. If a line thickness unit is defined in the portable terminal in advance, the controller 170 may instruct the display unit 154 to display a line image having a predefined thickness corresponding to the inputted pressure. For example, the line thickness may be defined in three levels in the portable terminal. If the magnitude of the pressure corresponding to each level is defined, the controller 170 may determine the pressure magnitude of the drawing motion input by user and may instruct the display unit 154 to display a line image with a line thickness corresponding to the determined pressure magnitude. Moreover, the display unit 154 can display the line image in consideration of the vibration time unit. For example, if the vibration time unit is defined with 0.1 seconds in the portable terminal and the user sets the vibration time range to within 10 second, the vibration time range can be divided and displayed in 100 sections.

The controller 170 can instruct the display unit 154 to display the line image according to the user-input drawing motion of each section (212). The user may select a line type including, for example, a solid line, a dotted line, and a dot-dash line, and may input the drawing motion in the vibration direction coordinate. The controller 170 may then determine whether an enter key is input (214). The drawing motion on the vibration pattern generation coordinate axis can be continuous or discontinuous. If the user finishes the drawing motion, the user may input the enter key indicating (to the controller 170) that the drawing motion is complete. In some cases, if a preset time elapses after inputting the drawing motion, the controller 170 can determine that the drawing motion is complete. The controller 170 may check the X value and the Y value of each location which configures a line image, and may determine the vibration pattern corresponding to the line image (216). If the enter key is not input, the controller 170 may continue to display a line image according to the drawing motion being input by the user. The enter key may be a designated key on the key input unit 160 or a preset input received by the touch sensor 152.

Next, the user can input a play key to determine whether the vibration pattern is correctly generated. If the user inputs the play button, the controller 170 may output, using the vibration generator 140, the vibration according to the generated vibration pattern. The user may input a save key to save the output vibration. The controller 170 may determine whether the user inputs a save key through the touch sensor 152 or the key input unit 160 (218).

FIG. 3E and FIG. 4D illustrate an example of a user inputting a save key. The save key may be a designated key on the key input unit 160 or a preset input received by the touch sensor 152. The save key may be provided in any suitable region of the touch screen unit 150. If the save key is not input, the method to generate a vibration pattern may be terminated. If the save key is input, the controller 170 may instruct the display unit 154 to display a window for inputting a vibration pattern name (220).

FIG. 3F illustrates a screen displaying a window for inputting a vibration pattern name. If the user inputs the vibration pattern name, the controller 170 may match the generated vibration pattern to the user-input vibration pattern name, and may store the matched vibration pattern and the vibration pattern name in the storage 130 (222). As shown in FIG. 3G, the controller 170 may instruct the display unit 154 to display a message indicating that the vibration pattern is saved in the storage 130.

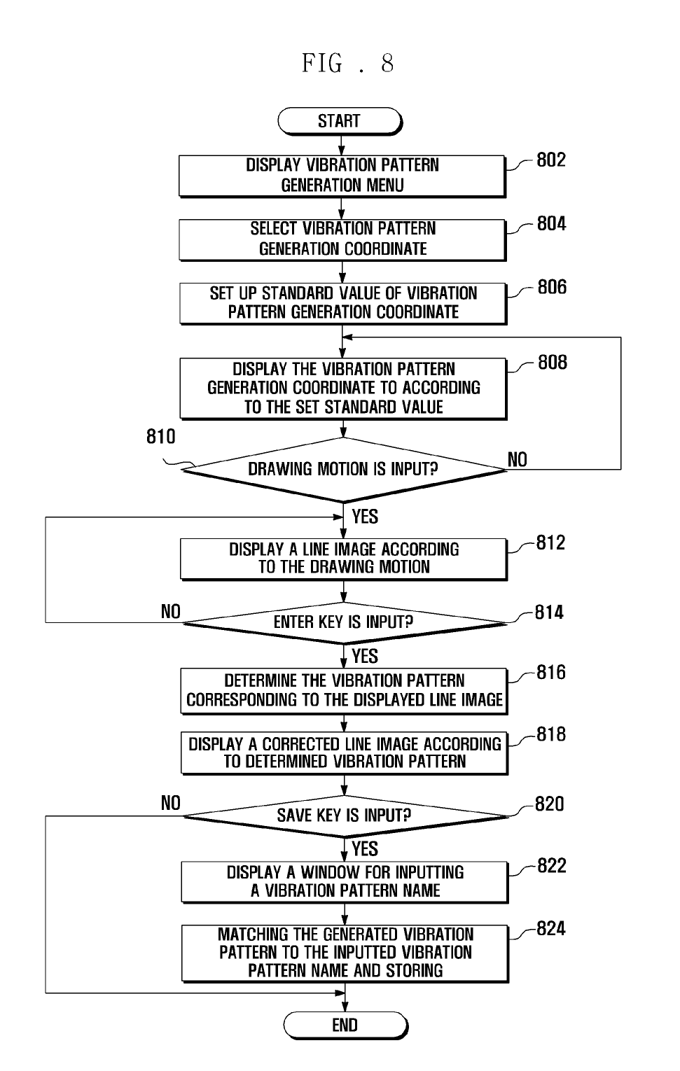

FIG. 8 is a flowchart illustrating another vibration pattern generation method according to exemplary embodiments of the present invention. According to the method illustrated in FIG. 8, a feedback may be provided to the user by displaying, on the display unit 154, a corrected line image according to the recognized vibration pattern. Hereinafter, the method of FIG. 8 shall be explained in more detail.

The second embodiment is characterized in that a feedback is provided to user by displaying a corrected line image based on the vibration pattern. A portable terminal user may select a vibration pattern generation menu, and, in response, the controller 170 may display a vibration pattern generation menu (802). The user may then select a vibration pattern generationcoordinate (804). Next, the controller 170 may instruct the display unit 154 to display a menu to set a standard value of the selected vibration pattern generation coordinate (806).

The controller 170 may set the value input by the user as a standard value of the vibration pattern coordinate, and may display the vibration pattern generation coordinate according to the set standard value on the display unit 154 (808). In some cases, step 802 to step 806 can be omitted, and if the user selects the vibration pattern generation menu, the controller 170 may instruct the display unit 154 to display a default vibration pattern generation coordinate.

The controller 170 may determine whether a drawing motion is input by the user within the vibration pattern generation coordinate (810). If no drawing motion is input, the display unit 154 may continue to display the vibration pattern generation coordinate displayed in step 808. If a drawing motion is input, the controller 170 may instruct the display unit 154 to display a line image according to the input drawing motion (812). The controller 170 may determine whether an enter key is input (814). The enter key may indicate to the controller 170 that the user is finished inputting the drawing motion. The enter key may be a designated key on the key input unit 160 or a preset input received by the touch sensor 152. Accordingly, if the enter key is input, the controller 170 may determine that the drawing motion is complete, and a vibration pattern corresponding to the displayed line image may be determined (816). If the enter key is not input, the controller 170 may continue to display a line image according to the drawing motion being input by the user.

As noted above, the vibration pattern may be determined based on the user-input vibration time unit, a vibration intensity unit, and a vibration pattern unit. For example, in case the vibration time is distinguished with a second unit, the controller 170 determines the vibration pattern according to each second unit. Moreover, in case the vibration intensity is also distinguished by one level, the controller 170 determines the vibration pattern with one level unit. If predefined vibration patterns are stored in the portable terminal, a vibration pattern may also be determined using a combination of the vibration patterns stored in the storage 130. For example, the controller 170 may instruct the display unit 154 to display a corrected line image based on the stored vibration patterns.

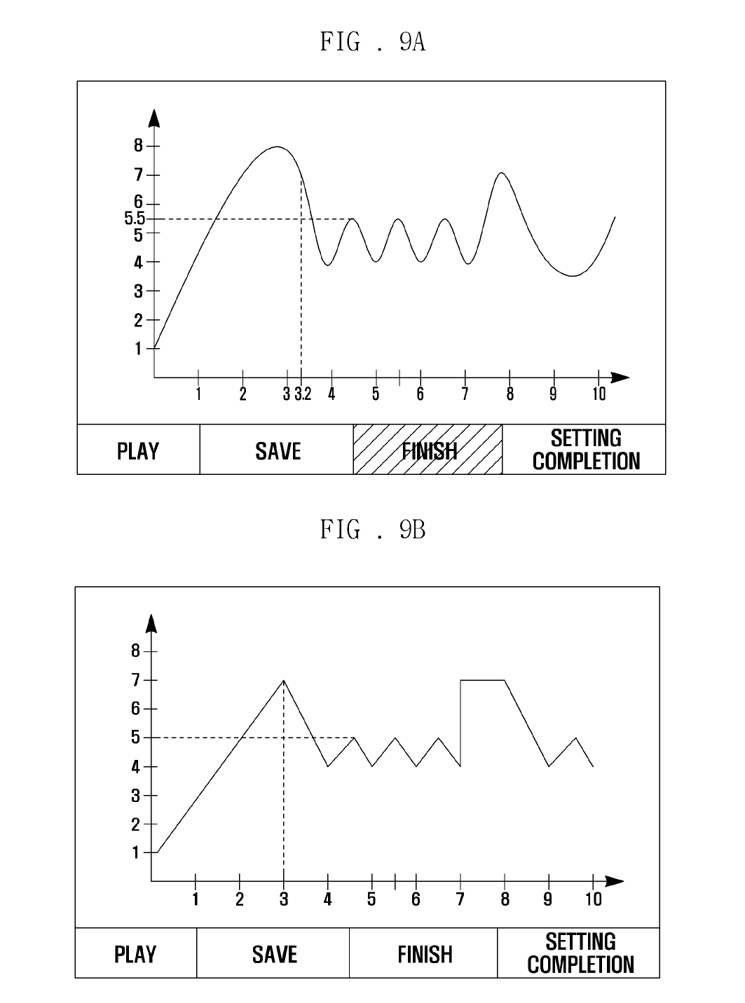

FIG. 9A illustrates a display screen showing a line image according to a user input drawing motion. If the user completes a drawing input and inputs an enter key, the controller 170 may determine the vibration pattern according to the vibration time unit and the vibration intensity unit, and may display a corrected line image.

For example, if the vibration time is set with a second unit, a line image corresponding to an input drawing motion may be displayed with a first line ascending approximately up to 3.2 seconds as shown in FIG. 9A. However, the controller 170 may determine that the first line ascends till 3 seconds, and may correct the first line as ascending till 3 seconds as shown in FIG. 9B. The corrected line may then be displayed on the display unit 154 accordingly.

The controller 170 may correct the incline of the line image based, for example, on the vibration time or the vibration intensity. For example, with respect to vibration intensity, in FIG. 9A, the maximum vibration intensity of a section of the line image between 4 seconds and 5 seconds is displayed as 5.5. However, the controller 170 may determine the vibration intensity of this section to be up to 5 and, as shown in FIG. 9B, may correct or change the maximum vibration intensity to 5 and display the line image on the display unit 154 accordingly. Moreover, if a vibration pattern list unit is stored in the storage 130, the controller 170 can reconfigure the line image with a combination of vibration pattern units.

For example, FIG. 9A or FIG. 9B may include a first vibration pattern from 0 seconds to 3 seconds, a second vibration pattern from 3 seconds to 4 seconds, a third vibration pattern from 4 seconds to 5 seconds, and fourth a vibration pattern from 7 seconds to 8 seconds. It can be appreciated that the vibration patterns from 4 seconds to 5 seconds, 5 seconds to 6 seconds, 6 seconds to 7 seconds, and 9 seconds to 10 seconds have the same third vibration pattern, and vibration patterns from 3 seconds to 4 seconds and 8 seconds to 9 seconds have the same second vibration pattern.

Accordingly, the controller 170 may determine that a vibration pattern generated according to the line image may be a combination of stored vibration pattern units corresponding to segments of the line image. The controller 170 may then instruct the display unit 154 to display a corrected line image. In some cases, if the controller 170 cannot specify one vibration pattern according to the drawing motion input by the user, the controller 170 can instruct the display unit 154 to display a plurality of line images corresponding to the vibration pattern.

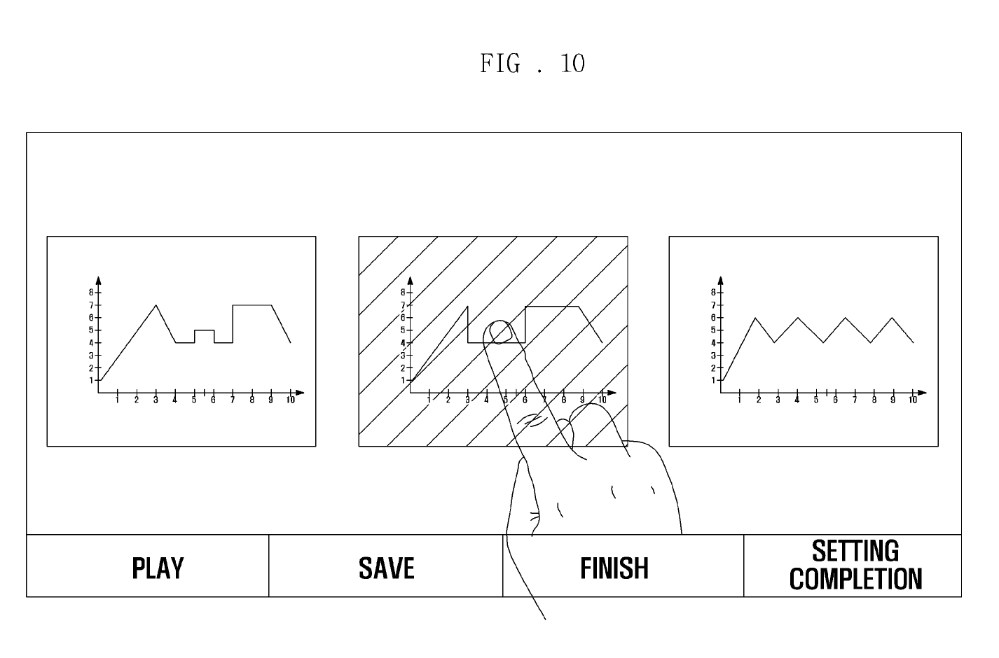

FIG. 10 illustrates a display unit displaying a plurality of corrected line images according to exemplary embodiments of the present invention.

The controller 170 may instruct the display unit 154 to list and display the plurality of corrected line images. If the user selects a specific image, the controller 170 may generate a corresponding vibration pattern. If the save key is not input, the method to generate a vibration pattern may be terminated. If the user inputs a save key, the controller 170 may detect input of the save key (820). Thereafter, the controller 170 may display a menu for inputting a vibration pattern name to the display unit 154 (822).

If the user inputs the vibration pattern name, the controller 170 may match the input vibration pattern name to the generated vibration pattern, and may store the matched vibration pattern name and vibration pattern in the storage 130.

In the method illustrated in FIG. 8, the displayed line image may be corrected before determining the vibration pattern, and accordingly a vibration pattern can be generated based on the corrected line image.

In the storage 130, line images corresponding to the vibration pattern may be stored. The controller 170 may correct the displayed line image based on line images stored in the storage 130. The controller 170 may compare line images and may extract, from the storage 130, the line image which is most similar to the line image displayed on the display unit 154. The corrected line image may then be displayed, and the controller 170 may generate a vibration pattern based on the corrected line image.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of generating a vibration pattern of a portable terminal, the method comprising:
displaying a coordinate for generating a vibration pattern;
displaying a line image on the displayed coordinate in response to an input by a user of the portable terminal;
generating a vibration pattern corresponding to the displayed line image; and
storing the generated vibration pattern.

2. The method of claim 1, wherein displaying the coordinate comprises displaying a two dimension coordinate comprising an X-axis corresponding to a vibration time axis and a Y-axis corresponding to a vibration intensity axis.

3. The method of claim 1, further comprising determining a vibration time range and a maximum vibration intensity value of the coordinate.

4. The method of claim 3, wherein displaying the coordinate comprises displaying an X-axis and a Y-axis according to the vibration time range and the maximum vibration intensity value, respectively.

5. The method of claim 1, further comprising determining a line type of the line image display on the coordinate.

6. The method of claim 1, wherein storing the generated vibration pattern comprises:
displaying a window to receive a vibration pattern name;
matching the received vibration pattern name to the generated vibration pattern; and
storing the generated vibration pattern and the vibration pattern name in a storage unit.

7. The method of claim 1, wherein displaying the coordinate comprises displaying a two dimension coordinate comprising an X-axis corresponding to a vibration time axis and a Y-axis corresponding to a vibration direction axis.

8. The method of claim 1, further comprising determining a vibration time range and a vibration direction of the coordinate.

9. The method of claim 8, wherein displaying the coordinate comprises:
displaying an X-axis of the coordinate according to the determined vibration time range; and
dividing a Y-axis of the coordinate into a number of classified areas, the number of classified areas corresponding to a number of determined vibration directions, wherein each vibration direction corresponds to a classified area.

10. The method of claim 9, wherein displaying the line image comprises displaying a line having a thickness corresponding to a pressure level of the input of the user.

11. The method of claim 10, wherein generating the vibration pattern comprises generating the vibration pattern with a vibration intensity corresponding to the displayed line thickness.

12. The method of claim 1, wherein generating the vibration pattern comprises:
generating a vibration pattern using a combination of at least two vibration patterns stored in the portable terminal; and
displaying a corrected line image corresponding to the generated vibration pattern.

13. The method of claim 1, wherein generating the vibration pattern comprises:
generating the vibration pattern according to a default vibration time range and a default vibration intensity of the portable terminal; and
displaying a line image corresponding to the generated vibration pattern.

14. The method of claim 1, wherein generating the vibration pattern comprises generating a plurality of vibration patterns based on the displayed line image.

15. The method of claim 14, further comprising displaying, in response to a selection of the user, one vibration pattern of the plurality of vibration patterns.

16. The method of claim 1, wherein generating the vibration pattern comprises generating a vibration pattern by using a coordinate value of the displayed line image.

17. A portable terminal for generating a vibration pattern, the portable terminal comprising:
a touch sensor to sense an input of a user of the portable terminal;
a display unit to display a coordinate for generating a vibration pattern and a line image according to the user input;
a vibration generator to generate a vibration;
a controller to receive an input signal corresponding to the user input, to determine the vibration pattern based on the user input, and to instruct the vibration generator to vibrate according to the vibration pattern; and
a storage to store the generated vibration pattern.

18. The portable terminal of claim 17, wherein the touch sensor is configured to sense a pressure of the user input.
